(19) United States
(12) Patent Application Publication
(10) Pub. No.: US 2008/0123626 A1
(43) Pub. Date: May 29, 2008

(54) ACCESSING TELEVISION AND VIDEO SERVICES ON A VIDEO PHONE OVER VOICE OVER INTERNET PROTOCOL NETWORK

(76) Inventor: ALEXANDER AIHAO YIN, QingDao (CN)

Correspondence Address: SANJEEV K. SINGH;Williams, Morgan & Amerson, P.C., Suite 1100, 10333 Richmond, Houston, TX, 77042, US

(21) Appl. No.: 11/534,750

(22) Filed: Sep. 25, 2006

(51) Int. Cl. H04L 12/66; H04L 12/56; H04N 7/173

(52) U.S. Cl. 370/352; 370/389; 725/87

(57) ABSTRACT

A method and apparatus for controlling access to a Voice over Internet Protocol network are provided. One embodiment of the method includes enabling an interface for an interactive control of at least one of a television channel and a video service over the Voice over Internet Protocol network from a video phone having a dial pad.

### BACKGROUND OF THE INVENTION

1. Field of the Invention

This invention relates generally to communication systems, and, more particularly, to Voice over Internet Protocol (VoIP) communication systems.

2. Description of the Related Art

Conventional land-line telephones and cellular telephones have been used for voice communications; however, availability of high speed data connections at the telephones has expanded their operations to other services than voice communications. For example, the Internet provides access to electronic information and resources available at various websites or portals. By using an Internet Protocol (IP) for a high speed data connection, the land-line telephones and cellular telephones may access data over the Internet or the World Wide Web. Alternatively, the Internet enables a user to have a telephone conversation over Internet Protocol (IP) networks instead of dedicated voice transmission lines.

Accordingly, voice and data may also be transmitted over a packet-switched network using a Voice over Internet Protocol (often referred to as VoIP). For providing VoIP, the Internet delivers voice to users by sending voice information in a digital form, such as voice packets rather than using a traditional set of circuit-committed protocols of Public Switched Telephone Network (PSTN). The Voice over Internet Protocol is a process that involves digitizing voice signals, organizing the digitized voice signals into packets, and transmitting the packets over a high speed digital connection. A receiving party reassembles the packets and plays the packets to produce an audio communication.

In addition to conventional land-line telephones and cellular telephones, VoIP may be used to incorporate voice and video communications in devices such as video phones, personal data assistants, laptop computers, desktop computers, and the like. To implement VoIP in a wireless telecommunication network, the speech data frames are embedded in Internet Protocol (IP) data packets.

For example, a VoIP network may use Internet Protocol (IP) for transmission of voice packets over packet-switched networks that employ one or more communication and network protocols capable of managing the transmission of the voice packets over an IP network that is a resource-shared network instead of a resource-dedicated network, such as the PSTN. Therefore, IP-network based VoIP applications provide a relatively cost-efficient platform for a variety of applications and services. One typical application of VoIP is to enable Internet telephony, also sometimes referred to IP telephony, over the IP network. The International Engineering Task Force (IETF) specifies a VoIP standard in Session Initiation Protocol (SIP) for multimedia communications over packet-based data networks including Local Area Network (LANs) or Wide Area Networks (WANs).

For some wireless telecommunications, such as cellular telephony, communications between base stations and mobile devices occur via a radio frequency (RF) system over an interface. High speed wireless shared access channels are designed to effectively transport data packet through air interface in the wireless telecommunication systems. Thus, the Voice over Internet Protocol is becoming increasingly common, at least in part because VoIP can handle voice and data communications homogeneously. Moreover, transmitting voice with VoIP may help reduce operational costs.

The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources.

Many Internet Service Providers (ISPs) have been offering a variety of VoIP services over their networks, but increasingly other networks including enterprise networks are adopting this trend. A VoIP service typically sends packets of digitized voice as another form of data over IP networks. Increasingly, VoIP service providers or Internet Protocol Television (IPTV) and Video on Demand (VoD) service providers have been deploying video services in a VoIP network (often referred to as a VoIP service). Examples of video services in a VoIP network include IPTV and VoD services.

To provide video services, while some video phones that use Internet Protocol (IP) support a common set of video codecs being used for the IPTV and VoD services, typically the VoIP network meets Quality of Service (QoS) requirements of these services. For example, IP video phones may use a signalling protocol called the Session Initiation Protocol (SIP) to establish a video session at SIP video phones. The SIP is the official protocol used to support various multimedia services that are provided to video phones. Exemplary multimedia services include Internet conferencing, Internet telephony, video telephony, event notification, instant messaging, and the like. For enabling various multimedia services, many of the SIP video phones deployed in the VoIP networks include a color display screen, such as Liquid Crystal Displays (LCDs) and webcams for peer-to-peer videophone calls or videoconferences. Thus, users of the VoIP services may desire to subscribe to such services through the SIP video phones. However, users of the SIP video phones may not access these services through the SIP video phones because use of the video capabilities on these phones is limited to video communications that can only be shared among the SIP video phone users.

To enable access to video services, generally an interactive control is desired. For accessing the IPTV and/or VoD services through video phones in a VoIP network, users also desire such an interactive control interface. One type of conventional means for controlling access to the IPTV and/or VoD services deploys a dedicated interactive control. In particular, the dedicated interactive control equipment includes set-up boxes and remote controllers, middleware software. Instead, in a conventional SIP video phone a user interface includes a dial pads with buttons for providing telephony signals including digital phone signals, such as Dual Tone Multi Frequency (DTMF) signals. Unlike the IPTV users accessing an IPTV service through the dedicated interactive control equipment, the SIP video phone users may not interactively control the VoIP services. Moreover, a conventional SIP video phone using telephony signals cannot control the IPTV and/or VoD services since the VoIP network and a network providing the IPTV and/or VoD services may not interwork with each other.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method and apparatus are provided for controlling access to a Voice over Internet Protocol network. One embodiment of the method includes enabling an interface for an interactive control of at least one of a television channel and a video service over the Voice over Internet Protocol network from a video phone.

### BRIEF DESCRIPTION OF THE DRAWINGS

The invention may be understood by reference to the following description taken in conjunction with the accompanying drawings, in which like reference numerals identify like elements, and in which:

FIG. 1 schematically illustrates one exemplary embodiment of a communication network, such as a Next Generation Network (NGN) that provides access to television and video services through a Voice over Internet Protocol (VoIP) network, in accordance one exemplary embodiment with the present invention;

FIG. 2 schematically illustrates one exemplary embodiment of a method for controlling access to the VoIP network shown in FIG. 1 by enabling an interface for an interactive control of a television channel and/or a video service over the VoIP network from a video phone having a dial pad, according to one illustrative embodiment of the present invention;

FIG. 3 schematically shows one exemplary embodiment of a method of using Session Initiation Protocol (SIP) messages to access Internet Protocol Television (IPTV) and/or Video on Demand (VoD) services from SIP video phones, consistent with one illustrative embodiment of the present invention;

FIG. 4 schematically illustrates one exemplary embodiment of a method of mapping telephony events to interactive control events associated with a session of an IPTV service in a soft switch of an interactive control internetworking interface, in accordance with one embodiment of the present invention; and

FIG. 5 schematically illustrates one exemplary embodiment of a user interface for an interactive control for the IPTV service from buttons in a dial pad of a video phone, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a method and apparatus for controlling access to a Voice over Internet Protocol (VoIP) network are provided. One embodiment of the method includes enabling an interface for an interactive control of at least one of a television channel and a video service over the Voice over Internet Protocol network from a video phone having a dial pad. By using one or more buttons on the dial pad, a user of the video phone may remotely control a television channel and/or streaming of video on demand. In other words, such an interactive control may enable the user to dial a predefined number on the dial pad to access the television channel and/or streaming of video on demand. A VoIP network may comprise an interworking interface for enabling an interactive control of the television channel and/or streaming of video on demand. By using the interworking interface between the VoIP network and an Internet Service Provider (ISP) network in a packet-based access network, the video phone may interactively control access to the television channel and/or streaming of video on demand. For example, an interactive control interface may be defined between a soft switch (SS) and application servers of an Internet Protocol TV (IPTV) and/or a Video on Demand (VoD) services for a Session Initiation Protocol (SIP) enabled video phone user to access and operate interactive control to the IPTV/VoD services. The soft switch may use interactive control event mapping tables and timers to map the user's Dual Tone Multi Frequency (DTMF) digit signals to IPTV/VoD interactive control events. The soft switch may collect the user's DTMF digit signals using the timers during an established IPTV/VoD session. The IPTV/VoD application servers may support the interactive control event operations from the SIP video phone subscribers. A SIP-based body format of an INFO message may be used to carry the telephony events associated with the IPTV/VoD services.

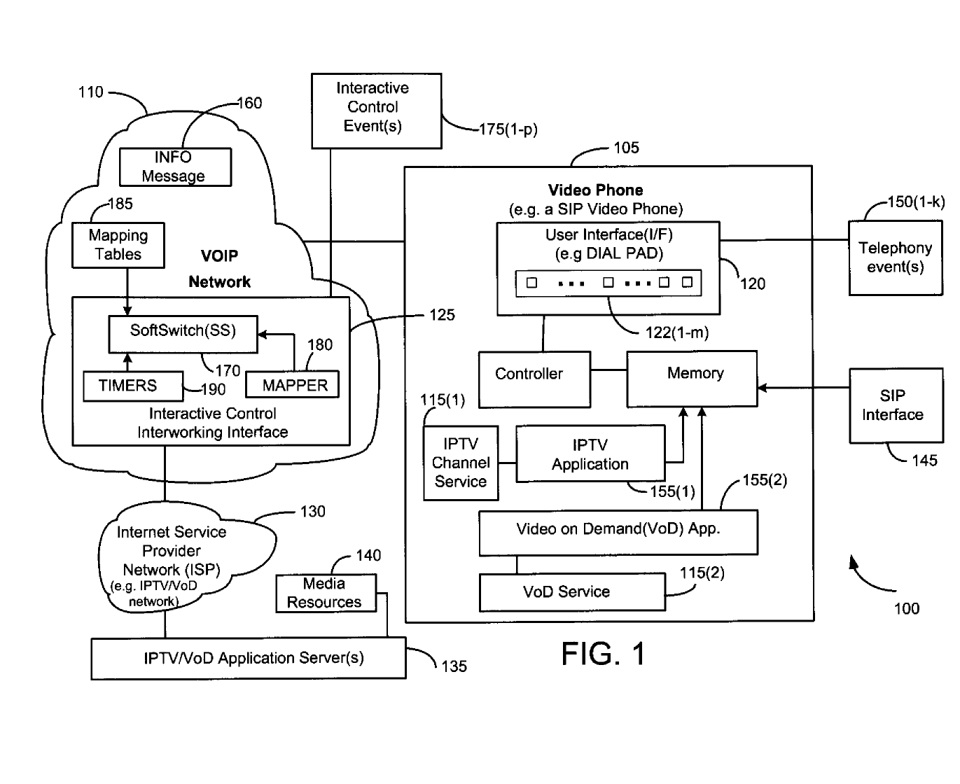

Referring to FIG. 1, a packet-based access network 100 may enable access to one or more television (TV) and video services on a video phone 105 over a Voice over Internet protocol (VoIP) network 110, according to one illustrative embodiment of the present invention. Examples of the television and video services include a television channel service, such as an Internet Protocol TV (IPTV) service 115(1) and a Video on Demand (VoD) service 115(2). The video phone 105 may comprise a user interface (I/F), such as a conventional dial pad 120 having a plurality of buttons 122(1-m) to provide access to the IPTV service 115(1) and/or VoD service 115(2). In particular, the dial pad 120 may provide an interactive control in that a user of the video phone 105 may interactively control the IPTV service 115(1) and/or VoD service 115(2) through the VoIP network 110.

By using one or more buttons 122(1-m) on the dial pad 120, a user of the video phone 105 may remotely control a television channel and/or streaming of video on demand. In other words, such an interactive control may enable the user to dial a predefined number on the dial pad 120 to access the television channel and/or streaming of video on demand. For example, a user at the video phone 105 may remotely control access to a television channel using Internet Protocol for the IPTV service 115(1) and/or a video service for streaming video on demand using the VoD service 115(2).

For controlling access to the IPTV service 115(1) and/or VoD service 115(2), the VoIP network 110 may comprise an interface, such as an interworking interface 125 for enabling an interactive control of the television channel and/or streaming of video on demand. By using the interworking interface 125 between the VoIP network 110 and the ISP network 130 in the packet-based access network 100, the video phone 105 may interactively control access to the television channel and/or streaming of video on demand. That is, the interworking interface 125 may connect the video phone 105 to an Internet Service Provider (ISP) network 130. In the illustrated embodiment, the ISP network 130 includes an IPTV network and/or a VoD network, which are communicatively coupled to one or more Application Server (ASs) 135. An Application Server (AS) 135 for a TV or video service, such as a Home Subscription Server (HSS) is known in the art and in the interest of clarity only those aspects of the operation of these elements that are relevant to the present invention will be described further herein.

Furthermore, persons of ordinary skill in the art having benefit of the present disclosure should appreciate that, in alternative embodiments, the Application Server (ASs) 135 may include more, fewer, and/or different media resources 140 for use in the packet-based access network 100. Additionally, the packet-based access network 100 may include one or more units that may be responsible for registration, routing and forwarding of Session Initiation Protocol (SIP) messages and charging. The SIP protocol is used for session control in the VoIP network 110. The SIP protocol defines the messages to setup and tear down sessions (e.g. void calls, video calls, etc): such as INVITE and BYE messages. These messages can be used to establish IPTV/VoD video sessions.

The Application Servers (ASs) 135 may include IPTV/VoD application servers to control the IPTV/VoD media resources 140 to deliver the video streams to the subscribed users. Using the SIP protocol, the application servers 135 may establish IPTV or VoD sessions to the VoIP network 110.

In operation, the video phone 105 may establish a video session using a Session Initiation Protocol (SIP) interface 145 with the interworking interface 125. In one embodiment, the packet-based access network 100 may provide connectivity in accordance with an Internet Protocol (IP) Multimedia Subsystem (IMS) that defines standards for using the Session Initiation Protocol (SIP) interface 145 to support various television and video services. However, persons of ordinary skill in the art having benefit of the present disclosure should appreciate that the present invention is not limited to the packet-based access network 100 that operate only in accordance with the aforementioned systems and/or protocols.

At the dial pad 120, pressing of the buttons 122(1-m) may indicate a plurality of corresponding telephony event(s) 150(1-k). A telephony event 150 may generate a digit phone signal, such as a conventional Dual Tone Multi Frequency (DTMF) digital signal associated with a telephony event indication. Accordingly, pressing of the buttons 122(1-m) by a user may define a set of events for an Internet Protocol Television (IPTV) application 155(1) and a Video on Demand (VoD) application 155(2). While the IPTV application 155(1) may enable the IPTV service 115(1) at the video phone 105, the VoD application 155(2) enables the VoD service 115(2).

Consistent with one embodiment, for example, to establish a video session for a television channel between the video phone 105 and an audio-video media resource 140 associated with the IPTV service 115(1) in the ISP network 130, the IPTV application 155(1) may use the SIP 145 in the VoIP network 110. During an established video session, the IPTV application 155(1) and VoD application 155(2) may use a protocol message, such as an INFO message 160 of a session protocol, such as the SIP interface 145 to exchange control information. The INFO message 160 may carry a telephony event 150 indication over the VoIP network 110 to the interworking interface 125.

As an example, a conventional SIP INFO method may exchange control information during an established session. In the VoIP network 110, a set of telephony events 150 may be defined to be carried in the INFO message 160, such as the DTMF digit signal event, flashook event, and the like. Using the SIP INFO method, one or more SIP endpoints may support transfer of these telephone events.

Upon a user pressing one or more digit buttons 122 on the dial pad 120, an interactive control may trigger the video phone 105 to send out the INFO message(s) 160 that carry the telephony DTMF digit signals. Instead of using the IPTV application 155(1) to detect the telephony DTMF digit signals, the interworking interface 125 may provide mapping of these telephony DTMF digit signals to the interactive control events 175(1-p). When the IPTV/VoD services 115(1,2) prompt the user to input secret information such as credit card ID, user ID/password, the IPTV application 155(1) may not send the information in the telephony DTMF digit signals, risking disclosure of the secret information. By defining a set of telephony events 150 specifically for the IPTV and VoD applications 155(1,2) for the interactive control, the interworking interface 125 may ensure a secure delivery of the user input information.

In response to an input from a user on the dial pad 120, the IPTV application 155(1) and VoD application 155(2) may cause the video phone 105 to send the INFO message 160 including a Dual Tone Multi Frequency digital signal associated with the telephony event 150 indication. To transfer the telephony event 150 indication to the interworking interface 125, the IPTV application 155(1) and VoD application 155(2) may use one or more endpoints of the SIP interface 145.

The interworking interface 125 may comprise a soft switch 170 to receive a Dual Tone Multi Frequency digital signal associated with the telephony event 150 indication. The soft switch (SS) 170 may host the video phone 105 and may manage a call control in the VoIP network 110. The soft switch (SS) 170 may support interworking with other external entities, which use the SIP protocol for establishing the audio/video sessions for the VoIP services.

The soft switch (SS) 170 may define a common set of interactive control event(s) 175(1-p) for communicating between the VoIP network 110 and the application server(s) 135 for the IPTV application 155(1) and VoD application 155(2). By using the soft switch (SS) 170, the interworking interface 125 may provide support for the common set of interactive control event(s) 175(1-p) at the application server(s) 135. That is, the common set of interactive control events 175(1-p) may provide the communication between the VoIP network 110 and the IPTV/VoD application servers 135 in that the soft switch (SS) 170 maps the telephony DTMF digit signals to the interactive control events 175(1-p). The IPTV and VoD application servers 135 may support the interactive control events 175(1-p) and implement an interactive control accordingly. The soft switch (SS) 170 may use of the INFO message 160 to carry the interactive control events 175(1-p) after mapping the telephony events 150(1-k).

The soft switch (SS) 170 may further comprise a mapper 180 to map one or more telephony event(s) 150(1-k) to an event associated with the interworking interface 125 for the interactive control of the television channel for the IPTV service 115(1) and streaming of video on demand for the VoD service 115(2). In the video session, the mapper 180 may map, from the video phone 105, one or more Dual Tone Multi Frequency telephony signals associated with the telephony event(s) 150(1-k) to an interactive control event 175(1) based on the Session Initiation Protocol interface 145.

To map multiple Dual Tone Multi Frequency telephony signals from a user to a particular interactive control event 175(1), the soft switch 170 may use one or more mapping tables 185 in the VoIP network 110. The following TABLE 1 shows the mappings of the interactive control events 175(1-p) to DTMF digit patterns for the IPTV service 115(1):

TABLE 1
IPTV interactive control events

| | Event | DTMF | |
|---|---|---|---|
| IPTV Control event | Type | patterns | Note |
| SelectChannel | Normal | N_{1..2} | 1 or 2 digits channel number |
| PreviousChannel | Normal | *_{1..5} | 1 to 5 of “*”, can skip up to |
| | | | 5 channels |
| NextChannel | Normal | #_{1..5} | 1 to 5 of “#”, can skip up |
| | | | to 5 channels |
| UserInput_CreditCard | Prompt | N₁₆ | 16 digit credit card number |
| | | | input |
| UserInput_Account | Prompt | N₁₀ | 10 digits user account |
| UserInput_Password | Prompt | N₆ | 6 digits user password |
| . . . | | . . . | . . . |

The following TABLE 2 shows is a list of VoD interactive control events mapped from the DTMF digit patterns.

TABLE 2
VoD interactive control events

| | Event | DTMF | |
|---|---|---|---|
| VoD Control event | Type | patterns | Note |
| PlayOrPauseVideo | Normal | * | Play or pause video |
| | | | stream |
| StopVideo | Normal | # | Stop video stream |
| | | | playing |
| PreviousChapter | Normal | ** | Skip to previous chapter |
| NextChapter | Normal | ## | Skip to the next chapter |
| ShowVideoMenu | Normal | 0 | Show menu of the video |
| | | | list |
| UserInput_VideoNumber | Prompt | N | Select video on the menu |
| UserInput_MenuPrevious | Prompt | * | Show previous menu |
| | | | items |
| UserInput_MenuNext | Prompt | # | Show next menu items |
| . . . | | . . . | |

The soft switch (SS) 170 may add new routes to the IPTV and VoD services 115(1,2) respectively. For example, new service access numbers may be assigned to route a call to the IPTV and the VoD networks of the ISP network 130. The soft switch (SS) 170 may check the video capabilities and the validity of a calling user before routing the call to the IPTV/VoD network. If the call is from a non-video user, the soft switch (SS) 170 may reject the call. In this manner, subscribed SIP video phone users may get access to the IPTV/VoD network.

TABLE 3
New routes to IPTV/VoD services

| Routing Number | Route Destination | App Type | Event Table |
|---|---|---|---|
| +86-800-555-5555 | as4voip.iptv.com | IPTV | Event_Table_IPTV |
| +86-800-666-6666 | as4voip.vod.com | VoD | Event_Table_VoD |

The interactive control event tables (example: Table 1 and Table 2) may be installed on the soft switch (SS) 170 for IPTV and VoD application servers 135. Once a SIP video phone subscriber dials to the IPTV/VoD network to access a video, the soft switch (SS) 170 begins to collect and map the user's DTMF digital signals to the interactive control events 175(1-p) and send the mappings to the IPTV/VoD application servers 135.

The soft switch (SS) 170 may use one or more timers 190 to collect the Dual Tone Multi Frequency telephony signals during an established session of the IPTV service 115(1) and/or VoD service 115(2). To collect and/or filter the user's DTMF digits the timers 190 may include an inter-digit timer, a first digit timer, and a next event timer. For example, the inter-digit timer may have a default value of 1 second, the first digit timer may have a default value of 5 seconds next event timer may have a default value of 2 seconds. The inter-digit timer may start when the soft switch (SS) 170 receives a DTMF digit, but still needs to wait for the next digit for other possible mappings. This timer expires when no subsequent DTMF digit is received. The soft switch (SS) 170 may then map the digits collected to the interactive control event 175. The first digit timer may start when collecting the User Input event digits. Once the 1^{st} DTMF digit is received this timer stops. The next event timer may allow the application server 135 sufficient time to perform media operations. This timer may start after the soft switch (SS) 170 completes mapping and finishes with sending of an interactive event 175. The DTMF digits received during a timer interval may be ignored to deny a particular user constantly performing media operations, which otherwise increases the burden of the IPTV/VoD media resources 140.

The video phone 105 may comprise a controller 190 and a memory 195. The memory 195 may store the Session Initiation Protocol interface 145, the IPTV application 155(1) for providing the IPTV service 115(1), and the VoD application 155(2) for providing the VoD service 115(2). The controller 190 may control the dial pad 120 to operate the IPTV application 155(1) and/or the VoD application 155(2) based on the Session Initiation Protocol interface 145. The controller 190 may format body of the INFO message 160 to carry an indication of the telephony event(s) 150 for the IPTV application 155(1) and/or the VoD application 155(2).

In response to a user input at the dial pad 120, the controller 190 may cause an application, such as the IPTV application 155(1) and/or the VoD application 155(2) stored at the video phone 105 to trigger a prompt event. The prompt event may enable the video phone 105 to collect the user input. Upon receiving a request for a user input event at the soft switch (SS) 170 from the application server(s) 135, the interworking interface 125 may collect the user input to map the telephony event(s) 150. By using a pattern associated with the user input event, the interworking interface 125 may send a response the application server(s) 135 for that request. The controller 190 may enable the video phone 105 used by an end user to establish a video session (a video phone call, video conference, and the like) using the SIP interface 145. The video phone 105 may support one or more standard video codecs, such as MPEG, H261, H263, and the like, which may also be used by the IPTV/VoD services 115(1,2).

According to one embodiment, the interactive control events 175(1-p) may be categorized into two types, a normal even and a prompt event. The normal event may be sent one way from the soft switch (SS) 170 to the IPTV/VoD application servers 135 during the normal time, when user is watching the video. They are mapped statically from the DTMF digit signals, which are triggered by the user dial pad operations during the normal time. Examples of the normal events include a SelectChannel and PlayVideo, events. The prompt event may be triggered by the IPTV/VoD applications 155(1,2) to collect user input for authentication, verification, billing information, and the like. The IPTV/VoD application servers 135 may send a User Input event request to the soft switch (SS) 170, while playing the prompt information to the user via an audio/video interface. Then the soft switch (SS) 170 may begin to collect and map the user's digital DTMF signals, and send the User Input event response back to the IPTV/VoD application server 135. One or more patterns of the User Input event may also be statically defined on the soft switch (SS) 170 in some embodiments.

The interactive control events 175(1-p) may be encrypted when delivered out of the VoIP network 110, in case the secret user input (such as credit card number, password, etc.) is indicated to be eavesdropped. For example, the conventional SIP encryption methods may be used.

In response to receiving the telephony event(s) 150 from the dial pad 120, at the soft switch (SS) 170, the interworking interface 125 may determine a type of the interactive control event 175. If the type indicates a normal event when the user is watching a video, the soft switch (SS) 170 may send the normal event in a one way communication to the application server(s) 135. For example, in the packet-based access network 100, a gaming video stream may be provided at a backend gaming application server for a gaming service at the video phone 105. In this way, by using the interworking interface 125 for the interactive control, the video phone 105 may interactively control the gaming service.

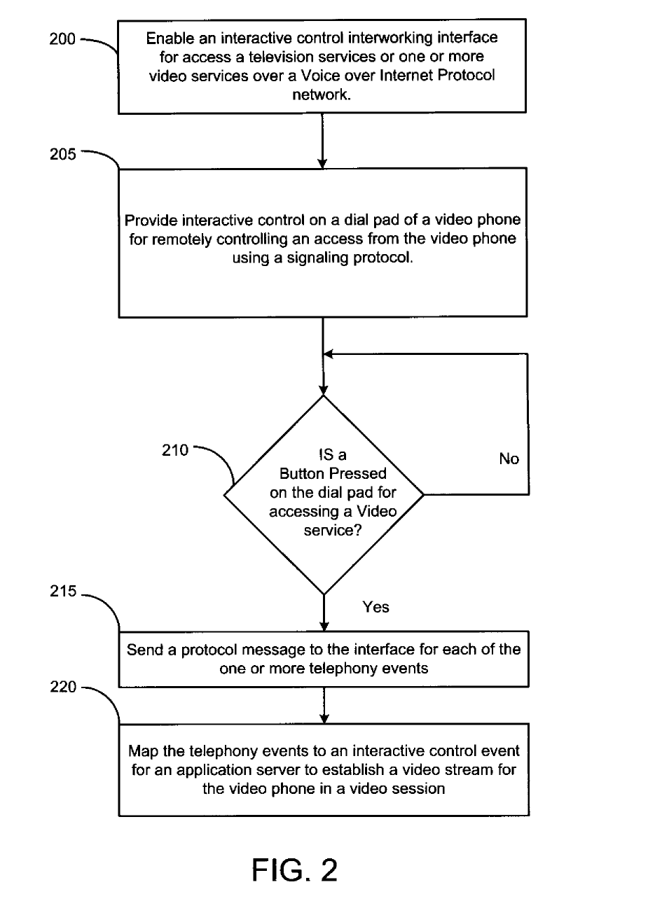

Referring to FIG. 2, a method for controlling access to the VoIP network shown in FIG. 1 is schematically illustrated according to one exemplary embodiment of the present invention. At block 200, the interworking interface 125 may enable an interface for an interactive control for accessing a television channel and/or a video service over the VoIP network 110 from the dial pad 120 at the video phone 105. According to one illustrative embodiment of the present invention, activation of the buttons 122(1-m) may trigger the interactive control on the dial pad 120 for remotely controlling an access from the video phone 105 using a signaling protocol, e.g., the SIP interface 145, as shown in block 205.

A check at a decision block 210 determines whether one or more particular buttons 122(1-m) have been pressed by a user on the dial pad 120 for remotely accessing a video service, such as the IPTV service 115(1) and/or VoD service 115(2). As with making a phone call, users may dial one or more predefined numbers to get access to the IPTV/VoD services 115(1,2). A video media steam may be carried using Real-Time Protocol (RTP) in standard codecs specified by H261 or H263 specifications.

At the dial pad 120, if pressing of one or more of the buttons 122(1-m) is indicated, at block 215, the IPTV application 155(1) may send one or more corresponding telephony event(s) 150(1-k) in the INFO message 160 to the soft switch 170 for enabling the IPTV service 115(1) at the video phone 105. Likewise, the VoD application 155(2) may enable the VoD service 115(2) by sending one or more respective telephony event(s) 150(1-k) to the interworking interface 125. By using the mapping tables 185, at block 220, the mapper 180 may map the telephony event(s) 150(1-k) to a particular interactive control event 175(1) for the application server(s) 135 to establish a video stream for the video phone 105 in a video session.

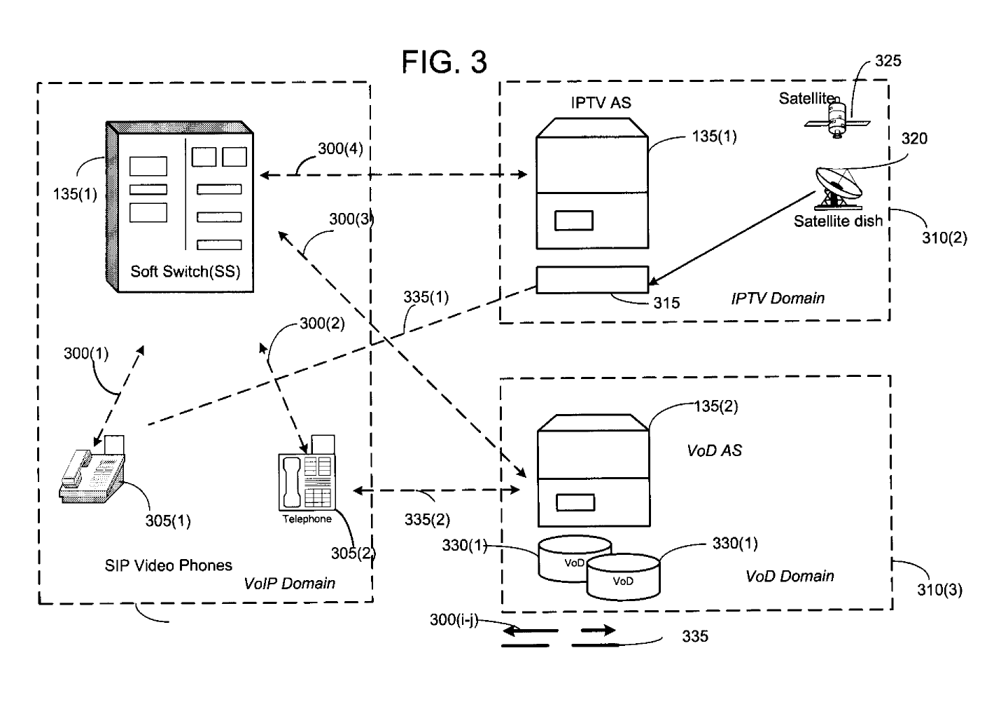

Turning now to FIG. 3, a method of using Session Initiation Protocol (SIP) messages 300(1-j) to access the IPTV service 115(1) and/or VoD service 115(2) from the video phone 105, such as SIP-enabled video phones 305(1-2) is schematically shown consistent with one illustrative embodiment of the present invention. Using the SIP messages 300(1-2), the SIP-enabled video phones (EP) 305(1-2) and a soft switch (SS) 170a may communicate in a VoIP domain 310(1). The soft switch 170a may exchange SIP messages 300(3-4) to the interface with an IPTV domain 310(2) and a VoD domain 310(3), respectively. While the IPTV domain 310(2) may comprise an IPTV application server 135(1), a TV signal receiver 315, a terrestrial antenna 320 to communicate with a satellite 325, the VoD domain 310(3) may include a VoD application server 135(2) and a database of VoD titles or items 330(1-2). The TV signal receiver 315 may provide an access to a TV channel through a first Real-time Transport Protocol (RTP) video stream 335(1) from the IPTV domain 310(2), the database of VoD titles or items 330(1-2) may provide a second RTP video stream 335(2) from the VoD domain 310(3).

The IPTV/VoD application servers 135 may support the interactive control events 175(1-p) and perform media operations accordingly. For example, if the IPTV application server (AS) 135(1) receives the NextChannel Normal event for a SIP video phone user, it will check the user's next channel and begin to change the media source 140 so that to play the media of the next channel to the SIP video phone user. The IPTV/VoD application server 135 may also store subscriber information and perform validation before playing certain video media, such as prompting for parent control password for adult related video. To this end, the application server (AS) 135(1) may send a Prompt event request to the soft switch (SS) 170a, so that the soft switch (SS) 170a collects the DTMF digits and maps to User Input events and sends back to the application server (AS) 135(1). Then the IPTV/VoD application server 135 verifies the data of the user input by comparing with the stored subscriber information to determine whether to play the video to the subscriber.

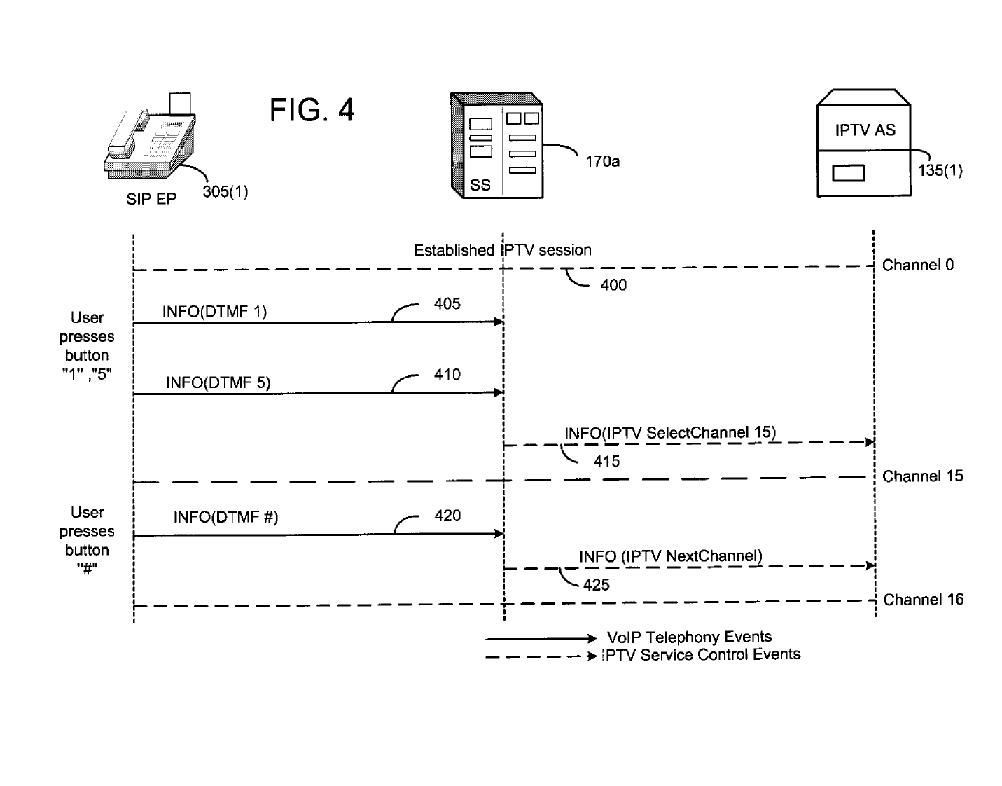

Referring to FIG. 4, a method of mapping between the telephony events 150(1-k) and the interactive control events 175(1-p) is schematically illustrated, in accordance with one embodiment of the present invention. By using the internetworking interface 125 shown in FIG. 1, for example, VoIP telephony events 150(1-3) associated with a session of the IPTV service 115(1) may be mapped to IPTV Service control events 175(1-2) by the mapper 180 in the soft switch 170a shown in FIG. 4.

In the illustrated embodiment, a subscriber (or end-user) may press buttons “1”, “5” of the buttons 122(1-m) into the dial pad 120 on a first SIP-enabled video phone (SIP-EP) 305 (1) to trigger the IPTV service 115(1) from the IPTV application server 135(1) in an established IPTV session 400. Alternatively, a subscriber may tap a portion of a graphical user interface using a pointing device or stylus to initiate the IPTV service 115(1) from soft number keys. The SIP-enabled video phone 305 (1) may then provide a first INFO message 160(1) indicating a first telephony event 150(1), as indicated by the arrow 405.

For example, the SIP-enabled video phone 305 (1) may send the first INFO message 160(1) including a “DMTF 1” signal to the soft switch (SS) 170a. The first SIP-enabled video phone 305 (1) may also provide a second INFO message 160(2) indicating a second telephony event 150(2) to send a “DMTF 5” signal, as indicated by the arrow 410. The soft switch (SS) 170a may use the mapper 180 to map the first and second INFO messages 160(1-2) into a first IPTV Service control event 175(1), as indicated by the arrow 415. The first IPTV Service control event 175(1) may indicate an IPTV “Select Channel 15” signal to the IPTV application server 135(1). As a result, the IPTV application server 135(1) may select the Channel 15.

Likewise, when a user presses the button “#,” a third INFO message 160(3) including a “DMTF #” signal may indicate a third telephony event 150(3) to the soft switch (SS) 170a, as indicated by the arrow 420. The soft switch (SS) 170a may map the third telephony event 150(3) in the third INFO message 160(3) into a second IPTV Service control event 175(2), which may indicate an IPTV “Next Channel” signal to the IPTV application server 135(1), as indicated by the arrow 425. Consequently, the IPTV application server 135(1) may change the Channel 15 to the next Channel 16.

As described above, in the IPTV domain 310(2), the IPTV application server 135(1) may cause the TV signal receiver 315 to provide the RTP video stream 335(1) to the first SIP-enabled video phone 305 (1). The IPTV application server 135(1) may uses the SIP message 300(4) to form a response message. For example, the IPTV application server 135(1) may parse the SIP message 300(4) to determine the subscriber's services and/or service-data, and composes the service data and the allowed operations into a response, which may be sent to the soft switch 170a. Techniques for operating the IPTV application server 135(1) are known to persons of ordinary skill in the art and, in the interest of clarity, will not be described further herein.

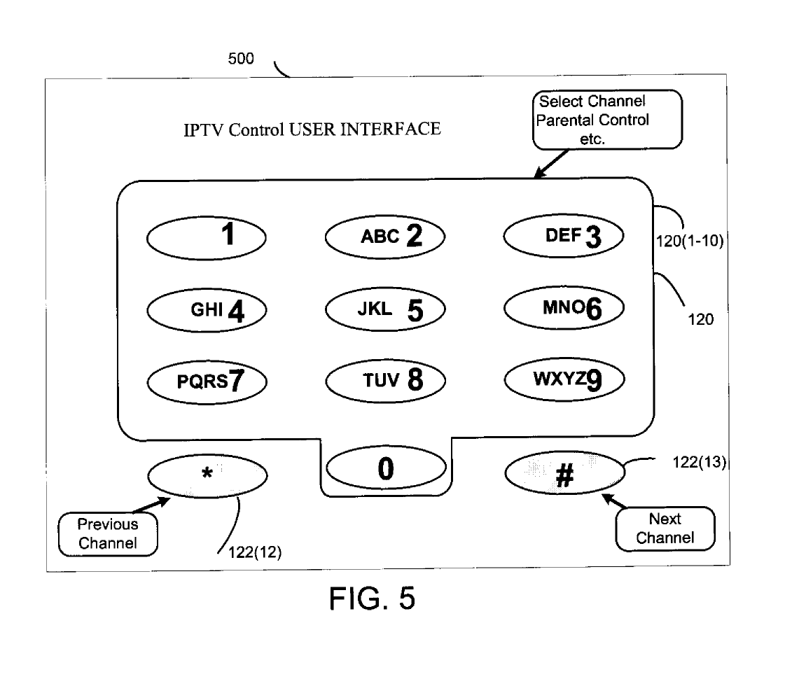

Finally, FIG. 5 schematically illustrates one exemplary embodiment of a user interface 500 for providing an interactive control for the IPTV service 115(1) using the buttons “0-9,” “*,” and “#” on the dial pad 120 from the video phone 105, in accordance with one embodiment of the present invention. More particularly, a user may press one or more of a set of buttons 122(1-10) “3” to select a Channel and/or to activate a parental control. A first button 122(12) labeled “*” on the dial pad 120 may effect a channel change from a current Channel to a previous Channel. Instead, a second button 122(13) labeled “#” on the dial pad 120 may effect a channel change from a current Channel to a next Channel.

Thus, an interactive control through the twelve buttons (0-9, * and #) of the dial pad 120 on the first SIP-enabled video phone 305 (1) may enable access to the IPTV and VoD services 115(1,2) from the VoIP network 110. Such an interactive control may avoid use of traditional forms of IPTV/VoD interactive control, such as set-top boxes, remote controllers, or middleware software for accessing the IPTV/VoD services 115(1,2) on personal computers. Since the first SIP-enabled video phone 305 (1) may support a common set of video codecs that are generally also used for IPTV and VoD streaming, and the VoIP network 110 may meet the QoS and bandwidth levels of the IPTV/VoD services 115(1,2), the VoIP users may access these services through the SIP video phones. By mapping the DTMF signals of the telephony events (1-k) to common IPTV/VoD interactive control events 175(1-p) for use in the Session Initiation Protocol (SIP) interface 145, the IPTV session 400 between the SIP-enabled video phones 305 (1,2) and the audio/video media resources 140 in the IPTV/VoD network may be established.

For the INFO message 160, a body type may be based on the SIP and according to one embodiment two SIP message body types may be defined for the IPTV and VoD events, respectively. In the SIP-based INFO message 160 body, a term “application/iptv” indicates an IPTV event and “application/vod” indicates a VoD event.

The following are examples of the format definitions of the SIP-based INFO messages 160 that may be used in the embodiments discussed above:

Event-Type Sub-Type Event-Data
Event-Type: IPTV or VoD
Sub-Type: The type of the user action, such as SelectChannel, StopVideo, and the like
Event-Data: optional, which contains the digits necessary for the event

A text-based definition is shown for use with both the switch (SS) 170a and the IPTV/VoD application servers 135(1,2). Following are the examples of the events:
1. From the soft switch (SS) 170a to the IPTV application server 135(1) to select a IPTV channel (Normal Event):

INFO sip:+86-800-555-5555@voip.net SIP/2.0
Via: SIP/2.0/UDP alexyin.voip.net;branch=z9hG4bK344a65.1,
SIP/2.0/UDP
Max-Forwards: 68
From:
To:
Call-ID:
CSeq:
Supported:
Expires:
Accept:
Contact:
Content-Type: application/iptv
Content-Length: 21
IPTV SelectChannel 15

### 2. From the VoD application server 135(2) to the soft switch (SS) 170a to collect a video number of the video title or item 330 (Prompt Event)

INFO sip:+86-800-666-1234@voip.net SIP/2.0
Via: SIP/2.0/UDP as1.vod.net;branch=z9hG4bK344a65.1, SIP/2.0/UDP
Max-Forwards: 68
From:
To:
Call-ID:
CSeq:
Supported:
Expires:
Accept:
Contact:
Content-Type: application/vod
Content-Length: 32
VoD UserInput_VideoNumber

2. The soft switch (SS) 170a collects the user input and sends the video number to VoD application server 135(2):

INFO sip:+86-800-666-6666@vod.net SIP/2.0
Via: SIP/2.0/UDP alexyin.voip.net;branch=z9hG4bK344a65.1,
SIP/2.0/UDP
Max-Forwards: 68
From:
To:
Call-ID:
CSeq:
Supported:
Expires:
Accept:
Contact:
Content-Type: application/vod
Content-Length: 34
VoD UserInput_VideoNumber 4

One example of the packet-based access network 100 is a next generation network (NGN). Wide spread usage of 3rd generation (3G) mobile communications systems, such as Universal Mobile Telecommunication System (UMTS) or Code Division Multiple Access (CDMA2000) has made the presence of next generation networks (NGN) inevitable. According to the International Telecommunication Union (ITU), a NGN is a packet-based access network that is capable of providing services including telecommunication services using multiple broadband, quality of service (QoS)-enabled transport standards. The ITU defines the QoS as the collective effect of service performance which determine the degree of satisfaction of a user of the service. It means it is the end user that decides whether he is satisfied with the provided QoS or not. Next generation networks may provide users with high end-to-end quality (high data rate, high coverage, new services etc.) mobile internet applications. Beside these demands, the next generation networks may use heterogeneous mobile communications comprising, for instance, 3G mobile system standards and IEEE 802.xx standards (e.g., WLAN, WIMAX).

In the NGN, service-related functions may be independent from underlying transport infrastructure. The NGN may offer an unrestricted access by users to different service providers. The NGN may support generalized mobility that allows a consistent and ubiquitous provision of services to users. The NGN may seamlessly handle convergence of the wireless and the fixed, wired infrastructure, ensuring a desired quality of service (QoS) on the Internet, for example. The QoS generally causes network elements to discriminate across traffic streams, treating each stream in a predefined manner based on performance constraints. The NGN may be related to any one of the 2G, 3G, or 4G standards and employ any one of the protocols including the UMTS, CDMA2000, GSM, Bluetooth or the like. However, use of a particular standard or a specific protocol is a matter of design choice and not necessarily material to the present invention.

As one example, the IP-based communications in the packet-based access network 100 comprise packets of information that carry real-time multimedia streams of data, voice, and video across a wireless network portion and/or a fixed, wired network portion thereof. In one embodiment, the soft switch 170 may cause packet forwarding in such real-time multimedia streams of such IP-based communications for an overall network performance or an end-to-end service provision. To handle several kinds of wireless and wired technologies, over the wireless network and/or the fixed, wired network portions the soft switch 170 may include various integrated communication interface(s), such as wireless interfaces and/or wireline interfaces. For example, the interworking interface 125 may further comprise one or more integrated communication interface(s) including wireless interfaces and/or wireline interfaces to simultaneously support connections based on a host of mobile communication standards, e.g., UMTS, IEEE 802.xx, GSM, and Bluetooth associated with different types of IP-based communications with the video phone 105.

The Application Server(s) 135 may provide one or more applications and/or services to the video phone 105 over the VoIP network 110. In one embodiment, an Application Server 135 is an IMS application server that may run IMS service logic for IMS subscribers. Exemplary services may include call forwarding, call waiting, a do-not-disturb function, and the like, as well as IMS services such as Internet conferencing, Internet telephony, video telephony, event notification, instant messaging, a buddy list, a black list, and the like. However, persons of ordinary skill in the art having benefit of the present disclosure should appreciate that the present invention is not limited to these exemplary services.

In one embodiment, the packet-based access network 100 may wirelessly communicate mobile data at a speed and coverage desired by individual users or enterprises. According to one embodiment, the packet-based access network 100 may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS adapts the Wideband Code Division Multiple Access (WCDMA) technology and includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), 802.16, Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of interaction among a phone that operates according to a Voice over Internet Protocol and a video streaming service, the method comprising:
mapping at least one telephony event formed in response to keystrokes entered into a dial pad of the phone to control events for interactive control of at least one video stream provided by the video streaming service.

2. A method, as set forth in claim 1, wherein mapping said at least one telephony event to the control events comprises mapping said at least one telephony event to control events for least one of a television channel using Internet Protocol and a video service for video on demand.

3. A method, as set forth in claim 2, further comprising:
establishing a video session at said phone using a Session Initiation Protocol interface.

4. A method, as set forth in claim 3, wherein mapping said at least one telephony event further comprises:
mapping, one or more Dual Tone Multi Frequency telephony events to an interactive control event of said at least one of said television channel and said video service based on said Session Initiation Protocol interface for use in said video session.

5. A method, as set forth in claim 3, wherein establishing a video session further comprises:
using said Session Initiation Protocol interface in said Voice over Internet Protocol network to establish a session for said television channel between said video phone and an audio-video media resource associated with said at least one of said television channel and said video service in an Internet Service Provider network.

6. A method, as set forth in claim 1, further comprising:
enabling a user of said video phone to remotely control said at least one of said television channel and said video service on demand using one or more buttons on said dial pad.

7. A method, as set forth in claim 6, wherein enabling a user further comprises:
enabling said user to dial a predefined number on said dial pad to access said at least one of said television channel and said video service on demand.

8. A method, as set forth in claim 1, further comprising: providing an interworking interface between said Voice over Internet Protocol network and said video service.

9. A method, as set forth in claim 1, further comprising:
using a protocol message of a session protocol for exchanging control information during an established session; and
carrying a telephony event indication over said Voice over Internet Protocol network in said protocol message using one or more endpoints of said session protocol to transfer said telephony event indication.

10. A method, as set forth in claim 9, further comprising:
in response to an input from a user on said dial pad, causing said video phone to send said protocol message including a Dual Tone Multi Frequency digital signal associated with said telephony event indication.

11. A method, as set forth in claim 10, further comprising:
defining a set of events for an Internet Protocol Television application and a Video on Demand application.

12. A method, as set forth in claim 11, wherein defining a set of events further comprises:
defining a common set of interactive control events for communicating between said Voice over Internet Protocol network and one or more application servers for said Internet Protocol Television application and said Video on Demand application.

13. A method, as set forth in claim 12, further comprising:
providing support for said common set of interactive control events at said one or more application servers.

14. A method, as set forth in claim 9, further comprising:
formatting body of said protocol message to carry an indication for an Internet Protocol Television application and a Video on Demand application.

15. A method, as set forth in claim 1, further comprising:
providing one or more mapping tables at a soft switch in said Voice over Internet Protocol network to map one or more Dual Tone Multi Frequency telephony events from a user to an interactive control event.

16. A method, as set forth in claim 15, further comprising:
using one or more timers at said soft switch to collect said one or more Dual Tone Multi Frequency telephony events during an established session of said at least one of said television channel and said video service.

17. A method, as set forth in claim 16, further comprising:
in response to a user input at said dial pad, causing an application at said video phone to trigger a prompt event to collect said user input.

18. A method, as set forth in claim 17, further comprising:
receiving a request for a user input event at said soft switch from said one or more application servers;
in response to said request, collecting said user input to map said one or more Dual Tone Multi Frequency telephony events; and
using a pattern associated with said user input event to send a response to said one or more servers for said request.

19. A method, as set forth in claim 18, further comprising:
determining a type of said interactive control event at said soft switch;
if said type indicates a normal event when said user is watching a video, sending said normal event in a one way communication to at least one of said one or more application servers.

20. A method, as set forth in claim 1, further comprising:
using said interface for the interactive control to interactively control a gaming service, wherein a gaming video stream is provided at a backend gaming application server.
